(19) United States
(12) Patent Application Publication
(10) Pub. No.: US 2025/0105418 A1
(43) Pub. Date: Mar. 27, 2025

(54) INTERCHANGEABLE BATTERY

(71) Applicant: Abdelhay Tazi, Casablanca (MA)

(72) Inventor: Abdelhay Tazi, Casablanca (MA)

(21) Appl. No.: 18/832,004

(22) PCT Filed: Mar. 23, 2023
(86) PCT No.: PCT/MA2023/000003

§ 371 Date: Jul. 22, 2024

(30) Foreign Application Priority Data
Jan. 25, 2022 (MA) 55423

(51) Int. Cl. H01M 50/247; H01M 50/244; H02J 7/00; H04M 1/02

(52) U.S. Cl. CPC H01M 50/247; H01M 50/244; H02J 7/0045; H04M 1/0235; H04M 1/0262; H01M 2220/30

(57) ABSTRACT

A mobile phone having an externally rechargeable battery has several advantages, namely: when the mobile phone battery is discharged, it is sufficient to press on the side of the battery to remove it and to replace it with a charged external battery. Our charger makes it possible to charge two batteries simultaneously, which is previously sufficient for non-stop use of the telephone, the two batteries, which are lightweight and non-bulky, being carried in the pocket.

The aim is to design a mobile device with the ability to remove and replace the battery by pushing on the edge of the battery or to plan this operation using a cart similar to the CD drive cart of a computer, to provide the possibility of two backup batteries to charge during the night.

The main goal is to never run out of battery due to discharge. Another solution to extend the mobile phone's charging time using an electrical outlet (if available) is to have an external battery (power bank), which needs to be charged for several hours, and its charge limit is quite significant, but it cannot be carried in a pocket.

Another advantage is that the battery charged inside the phone may overheat and cause damage, so it is preferable to charge the batteries outside to avoid this problem.

This phone with interchangeable batteries and the possibility of having as many charged batteries as needed on the independent charger will free up, for example, cafes, restaurants, trains, buses, boats, planes, and other places from equipping power outlets for their customers. The independent charger delivered with the phone can also function with the car's cigarette lighter outlet if the user is away from home for a long time.

In conclusion, this phone presents a significant advantage in addition to the savings of power outlets in all the public places mentioned above.

### DESCRIPTION OF THE FIGURES

FIG. 1 Mobile phone indicating the entry and exit of the battery.

FIG. 2 Insertion of the battery in the phone.

FIG. 3 Battery.

FIG. 4 Version for the battery cart chosen by the manufacturer.

FIG. 5 Charger for two batteries.

FIG. 6 Charger cable for alternating current.

FIG. 7 Car cigarette lighter charger cable.

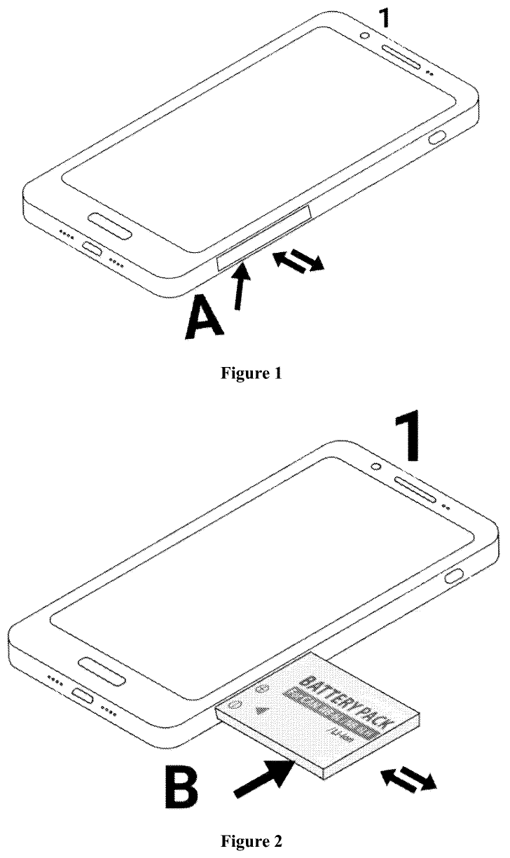

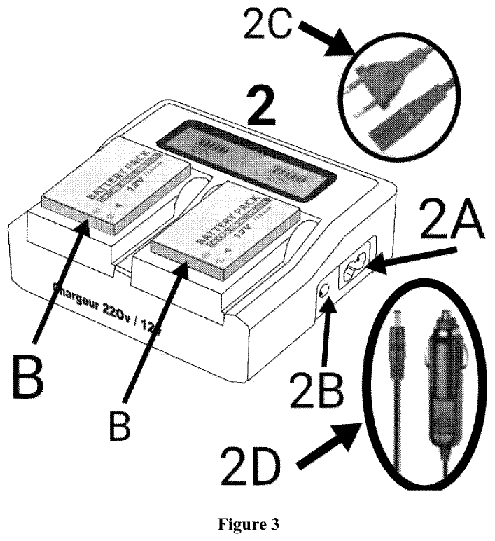

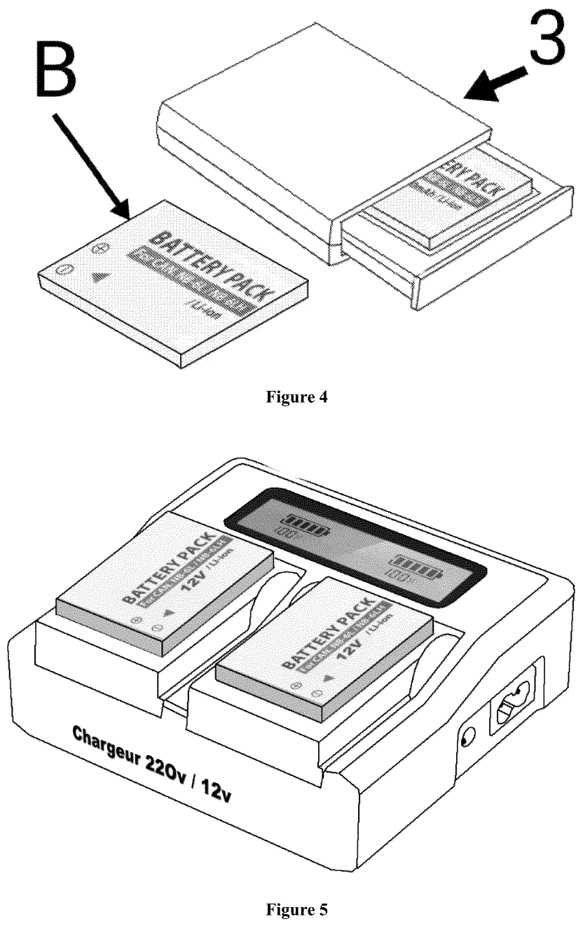

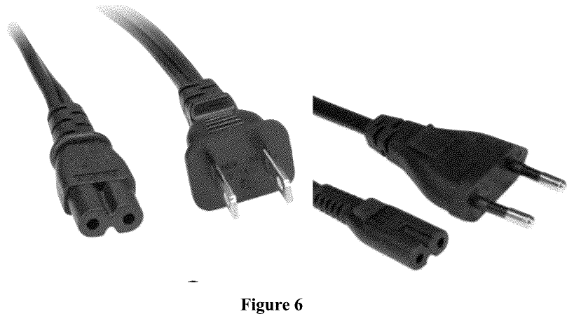

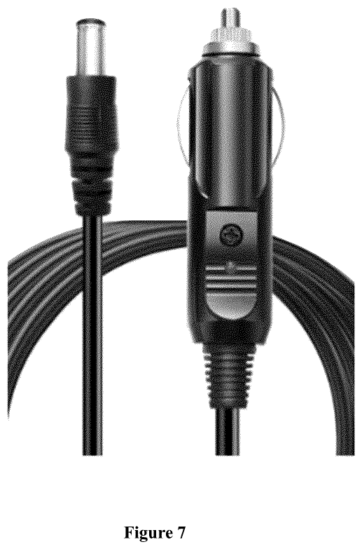

1. Removable battery characterized by its manual interchangeability.

2. The battery according to claim 1, characterized by being easy to remove and place by pushing on its side inside the phone.

3. The battery according to claim 1, characterized by having an appropriate joint to ensure its seal.

4. The battery according to claim 1, after being inserted into the phone, its outer edge and that of the phone will be aligned.

5. The battery according to claim 1, characterized by being rechargeable on an independent charger designed for two batteries at a time.

6. A removable battery characterized by being carried in a cart similar to the CD cart of a computer.
